(19) United States
(12) Patent Application Publication
(10) Pub. No.: US 2010/0011183 A1
(43) Pub. Date: Jan. 14, 2010

(54) METHOD AND DEVICE FOR ESTABLISHING AN INITIAL STATE FOR A COMPUTER SYSTEM HAVING AT LEAST TWO EXECUTION UNITS BY MARKING REGISTERS

(76) Inventors: Reinhard Weiberle, Vaihingen/Enz (DE); Bernd Mueller, leonberg-Silberberg (DE); Eberhard Boehl, Reutlingen (DE); Yorck Von Collani, Beilstein (DE); Rainer Gmehlich, Ditzingen (DE)

Correspondence Address: KENYON & KENYON LLP, ONE BROADWAY, NEW YORK, NY, 10004, US

(21) Appl. No.: 11/990,233

(22) PCT Filed: Jul. 25, 2006
(86) PCT No.: PCT/EP2006/064607

§ 371 Date: Mar. 11, 2009

(30) Foreign Application Priority Data
Aug. 8, 2005 (DE) 102005037226.0

(51) Int. Cl. G06F 9/318; G06F 12/06

(52) U.S. Cl. 711/170; 712/229; 711/E12.084; 712/E09.035

(57) ABSTRACT

A method for establishing an initial state in a computer system having at least two execution units, a switchover between a performance mode and a compare mode being performed, and during the switchover from the performance mode to the compare mode, an initial state for the compare mode being generated, wherein memories or memory areas that are potentially to be adapted for the initial state are provided with an identifier that indicates whether or not the data and/or instructions in these memories or memory areas must be modified for the initial state.

### FIELD OF THE INVENTION

The present invention is based on a method and a device for switching between at least two operating modes of a microprocessor having at least two execution units for executing program segments.

### BACKGROUND INFORMATION

Transient errors, triggered by alpha particles or cosmic radiation, are an increasing problem for integrated circuits. Due to declining structure widths, decreasing voltages and higher clock frequencies, there is an increased probability that a voltage spike, caused by an alpha particle or by cosmic radiation, will falsify a logic value in an integrated circuit. The effect can be a false calculation result. In safety-related systems, such errors must therefore be detected reliably.

In safety-related systems, such as an ABS control system in a motor vehicle, in which malfunctions of the electronic equipment must be detected with certainty, redundancies are normally provided for error detection, particularly in the corresponding control devices of such systems. Thus, for example, in known ABS systems, the complete microcontroller is duplicated in each instance, all ABS functions being calculated redundantly and checked for consistency. If a discrepancy appears in the results, the ABS system is switched off.

Such processor units are also known as dual-core or multi-core architectures. The different cores execute the same program segment redundantly and synchronously; the results of both cores are compared. An error is detected when the two results are compared for consistency. In the following, this configuration is called compare mode.

Dual-core or multi-core architectures are also used in other applications to increase output, i.e., for performance enhancement. Both cores execute different program segments, whereby a performance improvement can be achieved relative to the compare mode or a single-core system. This configuration is called output mode or performance mode. In a special form having identical cores, this system is also called a symmetrical multiprocessor system (SMP).

These systems are extended in that software is used to switch between these two modes by accessing a special address and through specialized hardware devices. In the compare mode, the output signals of the cores are compared to each other. In the performance mode, the two cores operate as a symmetrical multiprocessor system (SMP) and execute different programs, program segments, or instructions.

### SUMMARY OF THE INVENTION

In the microprocessors described in the related art, the internal states (register, pipeline, etc.) of the execution units must be adapted before switching over from the performance mode to the compare mode. For an execution unit having many registers, this may require a relatively large amount of computing time and prolong a mode change from the performance mode to the compare mode. The usual method for adapting the states of the execution units involves setting all registers in the execution units to the value zero or flagging their content as invalid.

The object of this invention is to shorten this change from the performance mode to the compare mode. Compared to the related art, the exemplary embodiments described here have the advantage that they enable a faster switchover from the performance mode to the compare mode since the registers of the execution units may be, depending on the mode in which they are involved, initialized quickly by using the method according to the present invention.

A method for establishing an initial state in a computer system having at least two execution units is advantageously described, a switchover between a performance mode and a compare mode being performed, and during the switchover from the performance mode to the compare mode, an initial state for the compare mode being generated, wherein memories or memory areas that are potentially to be adapted for the initial state are provided with an identifier that indicates whether or not the data and/or instructions in these memories or memory areas must be modified for the initial state. In the initial state, at least one memory or memory area assigned to the respective execution unit is advantageously occupied by at least one specifiable value if the identifier indicates this.

The generated initial state of the first execution unit is advantageously copied into a memory area, and the second execution unit takes over this initial state from this memory area if the identifier indicates this. The generated initial state of the first execution unit is advantageously taken over by the second execution unit via a special communication channel to at least one memory or memory area if the identifier indicates this. An initial memory or initial memory area is advantageously provided, and in it is specified which memories or memory areas must be modified for the initial state. A register or register record is advantageously provided, and in it is specified which memories or memory areas must be modified for the initial state. An initial memory or initial memory area is advantageously provided, and in it is specified which memories or memory areas do not have to be modified for the initial state. A register or register record is advantageously provided, and in it is specified which memories or memory areas do not have to be modified for the initial state. A device for establishing an initial state in a computer system having at least two execution units is advantageously included, a switchover between a performance mode and a compare mode being performed, and during the switchover from the performance mode to the compare mode, an initial state for the compare mode being generated, wherein at least one memory or memory area that is assigned to an execution unit is included that is designed such that it, provided it is potentially to be adjusted for the initial state, may be provided with an identifier that indicates whether the data and/or instructions in these memories of memory areas have to be modified for the initial state or not.

The memory or memory area is advantageously at least one register. An initial memory or initial memory area is advantageously included that is designed such that in it is specified which memories or memory areas have to be modified for the initial state. A register or register record is advantageously included that is designed such that in it is specified which memories or memory areas must be modified for the initial state. An initial memory or initial memory area is advantageously included that is designed such that in it is specified which memories or memory areas do not have to be modified for the initial state. A register or register record is advantageously included that is designed such that in it is specified which memories or memory areas do not have to be modified for the initial state.

Other advantages and advantageous embodiments are derived from the features described herein and of the specification, including the drawings.

### BRIEF DESCRIPTION OF THE DRAWINGS

FIG. 1 shows the general structure of a processor having two execution units and one comparator unit.

FIG. 2 shows a possible structure of an execution unit having two different register groups and of the processing logic.

FIG. 3 shows a possible structure of an execution unit having two different register records and of the processing logic. The register records in turn are divided into two different groups.

FIG. 4 shows two execution units with their internal registers, a buffer, and a connection between the execution units for transmission of the internal states.

FIG. 5 shows two execution units with their internal registers and a buffer for reading out the internal states for the initial state of the compare mode.

FIG. 6 shows the structure of a register having payload and control data.

FIG. 7 shows a multiprocessor having two execution units, as well as the internal registers of the execution units.

FIG. 8 shows a multiprocessor system having two execution units, their internal registers, as well as a special register.

### DETAILED DESCRIPTION

Some units in the drawings have the same number but are additionally labeled with a or b. If the number is used to reference without an additional a or b, then one of the existing units is intended but not a special instance. If only a particular instance of a unit is referenced, the identifier a or b is always put after the number.

In the following, a processor, a core, a CPU as well as an FPU (floating point unit), a DSP (digital signal processor), a coprocessor or an ALU (arithmetic logical unit), may all in this context be denoted as execution unit.

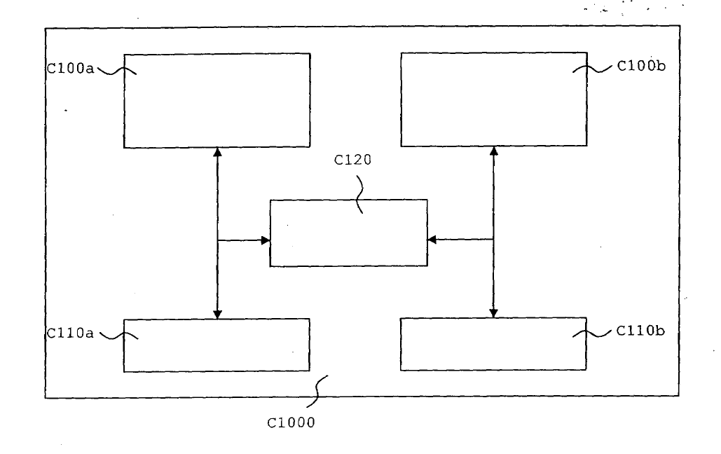

In FIG. 1, a processor system C1000 is shown that is made up of two execution units, C100a and C100b, and that is able to switch between a compare mode and a performance mode. In an exemplary embodiment, the execution units are identical. Both execution units C100a and C100b each have an interface C110a or C110b to the system bus via which, for example, the system accesses storage media such as RAM, ROM, flash media or peripheral units. If processor system C1000 is in the compare mode, the unit C120 compares the output signals of execution units C100a, C100b with each other.

This comparison may occur in a manner that maintains clock accuracy or at a fixed clock pulse offset, which means that in every pulse the output signals of at least two execution units C100a, C100b are compared by unit C120. If a difference exists between the compared signals, then unit C120 generates an error signal. In addition, the input signals of execution units C100a and C100b may also optionally be compared. If processor system C1000 is in the performance mode, comparator unit C120 is not active and no error signal is generated in the event of differences in the output signals of the execution units. The deactivation of the comparator unit can be achieved in different ways:

A comparison is not carried out by unit C120.

No signals for comparison are applied to unit C120.

Unit C120 performs a comparison, but the result is ignored.

When changing from the performance mode to the compare mode, it must be ensured that the internal state of the two execution units C100a and C100b is identical when the compare mode begins, that is, the time at which comparator C120 is activated. In the following, we call the state at the beginning of the compare mode, starting from which the calculations begin in the compare mode, the “initial state.”The states in the execution units must be identical so that in the error-free case the signals compared by C120 do not contain differences at any time in the compare mode. As a rule, differing states of the execution units in the compare mode will result in the generation of a differing output signal. The comparator would detect these differing output signals as errors, even though identical input signals exist and no error to be detected occurred during processing.

One way to achieve the same state in both execution units at the beginning of the compare mode is to flag all internal registers in the execution units as invalid. This possibility of flagging does not exist for all internal registers, however. These must then be set to a defined value that is identical in both execution units.

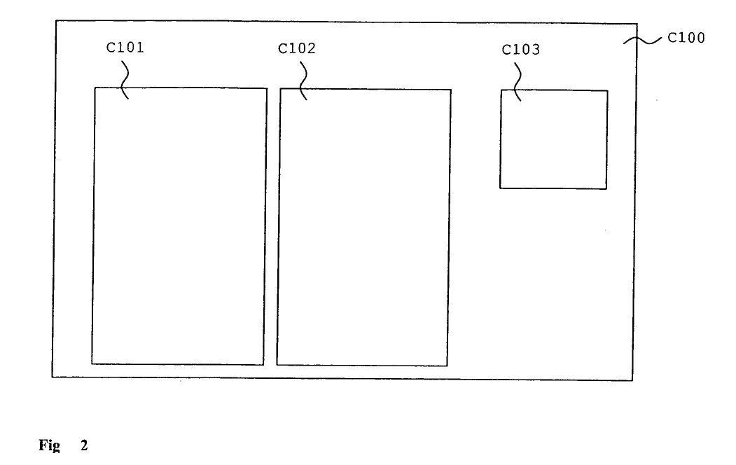

In a first specific embodiment, illustrated in FIG. 2, a switchover between two register records is described. In FIG. 2, a possible implementation of execution unit C100 is described. It contains at least two different groups of registers C101 and C102 and an internal logic C103. Group of registers C101 may be flagged as invalid. This means that, when accessing a register of this group that is flagged as invalid, internal logic C103 of the execution unit recognizes that the content for this register must be ascertained anew, for example by reloading from the RAM, ROM, flash media, or by recalculation. Registers from the other group C102 always have valid content. The work registers of an execution unit belong, for example, to this group.

If the system changes from the performance mode to the compare mode, these registers from C101 and C102 must be identical, as already mentioned, in both execution units C100.

This condition for register group C101, C102 does not necessarily have to apply from the time of switching over from the performance mode to the compare mode, but at the latest during the first read access to two identical registers in execution units C100 after the switchover to the compare mode. A usual method is to assign in a timely manner before or after switching over to the compare mode a fixed value to all registers from group C102. Irrespective of this, in the event of a switchover to the compare mode, registers from group C101 are flagged as invalid.

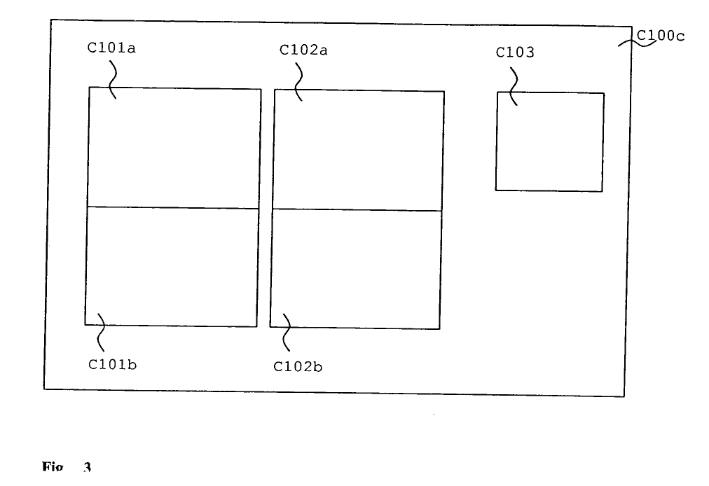

If an execution unit C100 is structured like in FIG. 3 as shown in C100c, this procedure can be accelerated by using two register records C101a, C102a, and C101b, C102b in each of the execution units. Instead of adapting the registers before, during, or after a switchover, the system uses different registers in the performance mode and in the compare mode. In the compare mode, the registers of the C101a and C102a group are used, while in the performance mode, the registers of the C101b and C102b group are used. When switching over to the compare mode or to the performance mode, the system switches between these register records. Once it has been ensured that the content of registers 101a and 102a is identical, for example, through an appropriate initialization when the processor is turned on, then these registers remain the same also during operation on both execution units. Thus, during a switchover from the performance mode to the compare mode, no adaptation of the register contents is necessary, since in the compare mode the system accesses only registers that are identical for both execution units C100a and C100b and can be written into only in the compare mode.

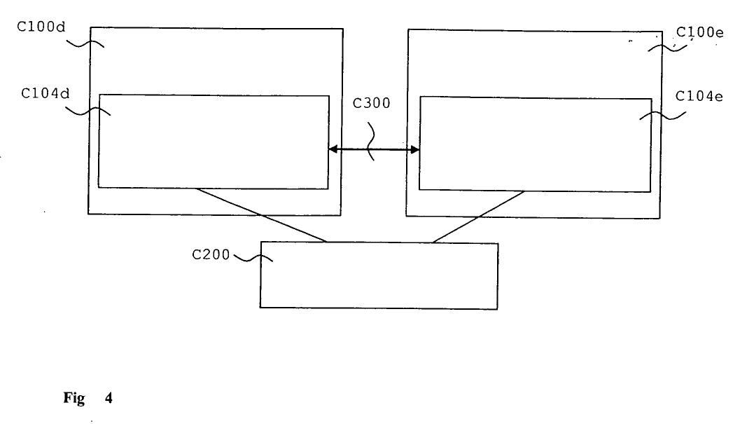

In a second specific embodiment, shown in FIG. 4, the copying of the internal state of an execution unit to the other execution unit is described. An additional possibility for accelerating the switchover operation from the performance mode to the compare mode is shown in FIG. 4. It involves copying the internal state C104d or C104e from one execution unit C100d, C100e to the other execution unit C100d or C100e, respectively. In operation, during a switchover from the performance mode to the compare mode, normally one execution unit will be ready for a switchover at an earlier time than the other execution unit. If the internal registers of an execution unit (C104d in the case of C100d, and C104e in the case of C100e) that is ready at an earlier time are initialized, before the switchover, to the values that are required in the compare mode, then the internal state of a second, temporally subsequent execution unit may be adapted by taking over the state from the first execution unit. If, for example, execution unit C100d is ready earlier for a switchover than execution unit C100e, then state C104d is copied to C104e during the switchover.

This copying of the internal state may be performed by using directly a connection C300 between the two execution units, over which connection the internal state is copied. Alternatively, the state may be copied from a first, temporally earlier execution unit to a (high-speed connected) buffer C200 from which a second, temporally subsequent execution unit takes over the state into the internal registers.

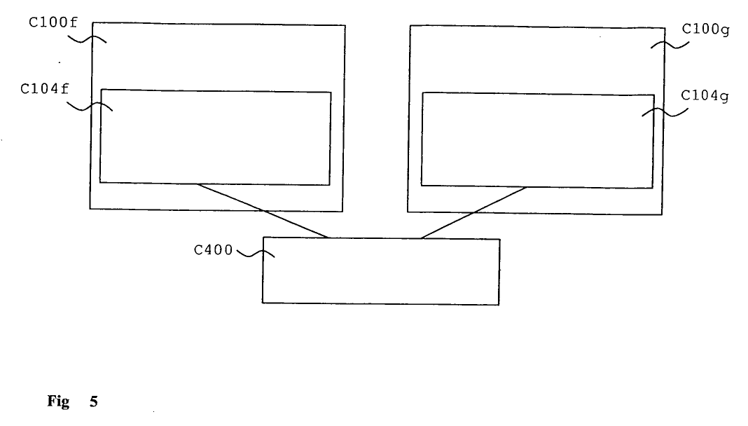

An additional specific embodiment, shown in FIG. 5, describes the initialization of the internal states for the compare mode by copying the register contents from a memory area having a high-speed connection. In this instance, it is assumed that when the performance mode begins, the internal states C104f, C104g of the at least two execution units C100f, C100g are always set to exactly one defined value. This value is stored in a memory C400 that has a connection that is as fast as possible to execution units C100f, C100g and thereby to registers C104f, C104g. This memory may be non-volatile. However, a volatile memory is also possible if the initialization state that is stored in the memory for the performance mode is, during the initialization of the multiprocessor system, copied from a non-volatile memory, received from an external data source, or generated by the multiprocessor system. For the switchover, or during the switchover from the performance mode to the compare mode, the initialization state for the compare mode stored in memory C400 is written into registers C104f, C104g of the at least two execution units C100f, C100g that are to be operated in compare mode.

In an additional specific embodiment, partial states are flagged that, in the event of a switchover to the compare mode, do not need to be adapted between the execution units. It is not always necessary to adapt all registers of the execution units in the event of a switchover from the performance mode to the compare mode. To avoid mistakenly detecting an error in the compare mode, only the registers of an execution unit that are actually used in the compare mode must be adapted with the registers of a second execution unit. This is the case or may be considered as an additional condition in software development especially in architectures that provide a large number of registers in the execution units. The number of registers that are used in a compare mode may be determined in any case. Now if not all registers are used, it is not necessary to adapt all registers, but rather only the used registers. For this reason, the present exemplary embodiment provides additional bits in every register. These bits may contain code that indicates whether or not the content of this register is to be adapted with the relevant registers of the other execution units when switching over from a performance mode to a compare mode. Alternatively, a special register may exist whose content defines which register of an execution unit must be adapted with the relevant registers of the other execution units. The adaptation itself may occur independently of the flags via the known methods or the methods presented here.

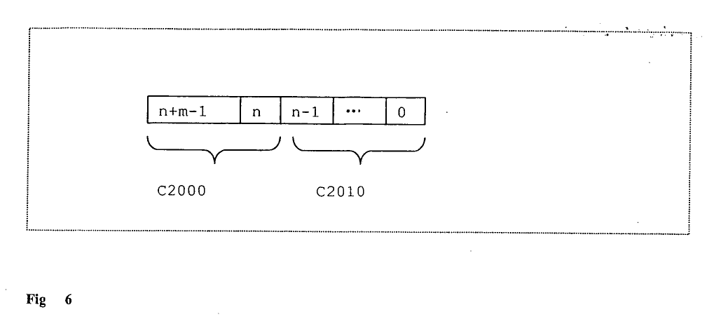

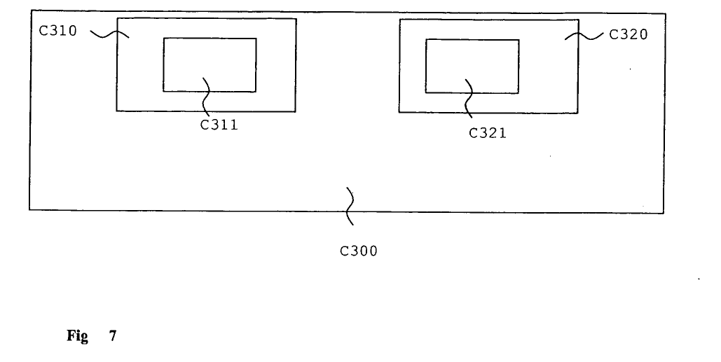

FIG. 7 illustrates a processor system C300 having multiple execution units C310, C320 with their registers C311, C321. Every register from C311, C321 is made up of n bits (n>1) having payload data (illustrated in FIG. 6 C2010). In addition to each of these n bits, there are m bits (m>=1) having control data (illustrated in FIG. 6 C2000). These m bits contain code that indicates whether an adaptation takes place during a change to the compare mode. If the control bits are, in the simplest case, made up of only one bit, a value of zero means, for example, that an adaptation does not need to take place and a value of one that an adaptation must take place. The evaluation of these bits occurs then during the switchover from the performance to the compare mode.

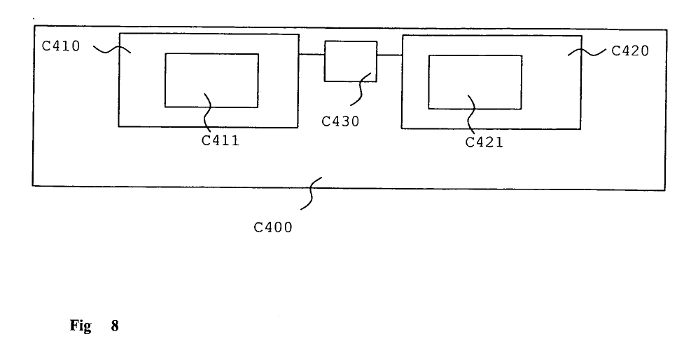

FIG. 8 illustrates an additional specific embodiment of the present invention having a processor system C400 that contains execution units C410, C420 with their registers C411, C422. In addition, processor system C400 has a register C430. The content of this register C430 defines which registers from C411, C421 of the execution units C410, C420 must be adapted in the event of a change to the compare mode. For example, register C430 may be implemented such that for every register from C411, C421 that is potentially to be adapted, one bit is provided in C430. If the relevant bit is set, the corresponding register must be adapted; if the bit is not set, the corresponding register does not have to be adapted. The evaluation of this register occurs then during the switchover from the performance to the compare mode. In an additional specific embodiment that is not illustrated in a figure, a central register C430, as shown in FIG. 8, is not provided, but rather a register is provided in every execution unit, which register performs the task of register C430. This means that this register contains code that indicates which registers of the execution unit must, in the event of a switchover from the performance mode to the compare mode, be adapted to the registers of at least one second execution unit. In the event of a switchover from a performance mode to a compare mode, though, it must then be ensured that the contents of these special registers are identical in all execution units to be synchronized.

1-14. (canceled)

15. A method for establishing an initial state in a computer system having at least two execution units, the method comprising:
performing a switchover between a performance mode and a compare mode;
generating, during the switchover from the performance mode to the compare mode, an initial state for the compare mode; and
providing identifiers for memories that are potentially to be adapted for an initial state, an identifier indicating whether at least one of data and instructions in the memories must be modified for the initial state.

16. The method of claim 15, wherein in the initial state, at least one memory assigned to a respective execution unit is occupied by at least one specifiable value if an identifier indicates this.

17. The method of claim 15, wherein a generated initial state of the first execution unit is copied into a memory, and the second execution unit takes over the generated initial state from this memory if an identifier indicates this.

18. The method of claim 15, wherein a generated initial state of the first execution unit is taken over by the second execution unit via a special communication channel to at least one memory if an identifier indicates this.

19. The method of claim 15, wherein in an initial memory, it is specified which memories must be modified for the initial state.

20. The method of claim 15, wherein a in a register record, it is specified which memories must be modified for the initial state.

21. The method of claim 15, wherein in an initial memory, it is specified which memories do not have to be modified for the initial state.

22. The method of claim 15, wherein in a register, it is specified which memories do not have to be modified for the initial state.

23. A device for establishing an initial state in a computer system having at least two execution units, comprising:
a switchover arrangement to switchover between a performance mode and a compare mode;
a generating arrangement to generate, during the switchover from the performance mode to the compare mode, an initial state for the compare mode; and
an assigning arrangement to assign at least one memory to an execution unit, if it is potentially to be adapted for the initial state, and to provide with an identifier that indicates whether at least one of data and instructions in the memories have to be modified for the initial state.

24. The device of claim 23, wherein the memory includes at least one register.

25. The device of claim 23, wherein an initial memory is included and which is arranged to specify which memories must be modified for the initial state.

26. The device of claim 23, wherein in a register record, it is specified which memories must be modified for the initial state.

27. The device of claim 23, wherein in an initial memory, it is specified which memories do not have to be modified for the initial state.

28. The device of claim 23, wherein in a register record, it is specified which memories do not have to be modified for the initial state.
